(19) United States
(12) Patent Application Publication
(10) Pub. No.: US 2026/0064477 A1
(43) Pub. Date: Mar. 5, 2026

(54) MEMORY-AWARE REAL-TIME SCHEDULING FOR DISTRIBUTED QUERY PROCESSING

(71) Applicant: Oracle International Corporation, Redwood Shores, CA (US)

(72) Inventors: Panagiotis Sioulas, Zurich (CH); Cagri Balkesen, Zurich (CH); Kaan Kara, Zurich (CH); Srinivasan Sholingur Asoori, Chennai (IN); Nitin Kunal, Zurich (CH); Shady Issa, Lisbon (PT); Mia Primorac, Zurich (CH); Abhinav Agarwal, Bangalore (IN); Deepa Dixit, Tokyo (JP); Nipun Agarwal, Saratoga, CA (US)

(21) Appl. No.: 19/058,851

(22) Filed: Feb. 20, 2025

Related U.S. Application Data
(60) Provisional application No. 63/689,678, filed on Aug. 31, 2024.

(51) Int. Cl. G06F 9/50; G06F 9/48; G06F 16/2455

(52) U.S. Cl. CPC G06F 9/5038; G06F 9/4881; G06F 16/2455

(57) ABSTRACT

Techniques for real-time scheduling for distributed query processing are provided. In one technique, a global counter and multiple local counters are stored, each local counter corresponding to a different query of multiple queries. Each query is scheduled based on the multiple local counters and the global counter. In response to determining that a particular query is waiting for data to arrive at a computing node, a first current value of the global counter is stored in association with the particular query. In response to determining that the data has arrived at the computing node: a current value of the global counter is identified; a difference between the second current value and the first current value is determined; and a current value of the local counter of the particular query is updated based on the difference.

### BENEFIT CLAIM

This application claims benefit under 35 U.S.C. § 119 (e) of provisional application 63/689,678, filed Aug. 31, 2024, by Sioulas et al., the entire contents of which is hereby incorporated by reference.

### TECHNICAL FIELD

The present disclosure relates generally to distributed query processing and, more particularly, to real-time scheduling of queries, which scheduling is based on current memory availability.

### BACKGROUND

Customer applications often submit queries concurrently to a database system using parallel connections. In such scenarios, the receiving database system should process all the incoming queries while meeting three criteria: predictability, high throughput, and reliability.

Regarding predictability, when processing concurrent queries, a database system should process an increased load with the same system resources (e.g., CPU and network). Thus, the latency of individual queries is expected to increase compared to scenarios where the queries run in isolation. However, latency degradation needs to be graceful; that is, a query that has lower latency than another query in isolation is also expected to have lower latency during concurrent execution. Computing systems, including database systems, formulate this requirement using the concept of fairness: performance degradation should be proportional to the number of queries running concurrently.

Regarding high throughput, a critical aspect of concurrent execution is the throughput, which is the rate of query processing. Throughput is important in two ways: 1) if all the concurrent queries are submitted at once, then throughput determines when the workload is finished end-to-end, and 2) if there is a continuous stream of incoming queries, throughput determines what the maximum query rate is that the database system can sustain. Hence, it is desirable for the database system to have as high throughput as possible, and, at the very least, not degrade during concurrent execution.

Regarding reliability, concurrent queries compete for the same resources. Due to this reason, a query that would otherwise succeed in isolation may fail in the presence of other concurrent queries. A prime example of such resources is memory. A query may require less than the total system's memory, but other running queries may leave it insufficient memory to execute. In such a scenario, the query fails with an out-of-memory (OOM) error. Such types of concurrency-induced errors are undesirable. Instead, a goal of database system design is to reliably and successfully run queries that would succeed in isolation.

One approach for conducting concurrent execution is to intelligently serialize the submitted queries. An example of a database system that implements serialization is Oracle's HeatWave MySQL. In serialized execution, queries submitted for scheduling are enqueued into an aging-based priority queue based on their execution-time estimate (generated by an optimizer) and a current timestamp. Each of those queries executes when it reaches the front of queue, and, when finished, allows for the next query in line to execute. Hence, a database system (e.g., a cluster of nodes connected to a shared database) processes only one query at a time. Serialization achieves reliability because, from the database system perspective, queries execute in isolation. However, it also has significant shortcomings in terms of predictability and throughput.

Serialization results in unpredictable query performance. Often, using a priority queue avoids long delays for fast queries. However, a priority query fails to achieve predictability consistently because: (1) it is based solely on estimates that can be inaccurate, (2) it eventually schedules long-running queries ahead of shorter-running queries due to aging, (3) it makes decisions only based on the information available at the time and thus can start a long-running query before the short-running queries arrive. In such scenarios, the latency of the short-running queries is severely penalized. This effect is highlight in the following two concrete examples.

In a first example, a database system is currently idle and two new concurrent connections, C1 and C2, are created. From these two connections, two queries, Q1 and Q2, are offloaded and submitted to a priority queue. In isolation, Q1 would take 1 second to complete whereas Q2 would take 100 seconds to complete. However, because the database system is idle, it will pick up the first query that arrives. One of two scenarios will occur. In scenario A, Q1 runs first and has the same performance as in isolation, whereas the impact to Q2 is minimal. In scenario B, however, Q2 arrives and runs first, and Q1's latency is 101 times higher than in isolation. From the perspective of a customer expecting a fast answer, the query appears to hang. The same behavior would be observed if the priority queue was full of long-running queries and a customer started a new interactive connection to submit a short-running interactive query.

In a second example, a database system is processing short-running queries with processing times of 1-2 seconds and there are multiple queries in a priority queue. A new connection submits a very-long-running query Q that takes 100 seconds, but the estimate is inaccurate and predicts a processing time of milliseconds (e.g., due to highly inaccurate estimates for the cardinalities of join results). Q is picked up for execution before the short-running queries and, thus, all the short-running queries will experience an additional latency of at least 100 seconds.

Serialization also results in limited throughput due to hardware underutilization. When processing queries in distributed environments, throughput is a function of the utilization of the hardware resources, i.e., CPU, memory bandwidth, and network bandwidth utilization. Ideally, query execution saturates these resources and, thus, processes the given plans as fast as possible. However, CPU and memory bandwidth-bound operator processing is not independent from network bandwidth-bound data transfers.

Distributed query engines, such as HeatWave, partition a query plan into tasks, i.e., sub-plans of operators that execute together. Each task's leaf operators read base or intermediate tables from memory or network, and the task's root writes an intermediate table to memory or network. Hence, each task needs to wait not only for its preceding tasks but also for any of its inputs that come from the network, and data transfers can only occur after the corresponding task has produced data to send. This is demonstrated in FIG. 1 through an example of a join query. The query plan on the left is depicted as a tree with two branches. Each operator (1-7) represents a task, denoted by a number. The black objects represent tables: an Orders table and a LineItem table. On the right-hand side of FIG. 1, the utilization of execution time (CPU and memory bandwidth) and network time (network bandwidth) by each task is depicted. The dependencies between tasks introduce gaps during which the corresponding resource is idle. Having only one running query at a time blocks a scheduling system from filling gaps with work from other queries and thus increasing throughput.

An alternative to serialized execution is to share a computer system's resources among multiple queries, typically in equal terms, and run them at the same time, concurrently. Systems such as PostgreSQL, IBM DB2, and Microsoft SQL Server spawn a dedicated OS thread for serving each connection, thus relying on the OS's ability to fairly share resources across threads but also suffering from context switching overhead. Other systems, such as MySQL, implement their own scheduler over either a pool of OS threads or threads pinned to CPU cores. The state-of-the-art approach used in Umbra efficiently implements stride scheduling for each of its core-affinitized threads and thus is able to scale to a large number of queries, while keeping synchronization overheads low. Overall, concurrent execution can address the above problems of serialized execution. FIGS. 2A-2B illustrate improved predictability and throughput.

Systems that support concurrent execution typically focus on sharing the CPU time fairly across the running queries, and do not consider other resources, such as network usage or memory. Existing concurrent execution approaches thus suffer from the following limitations.

First, scheduling focuses on fairly sharing CPU time across the different queries, even for distributed systems where network plays a crucial role for performance. However, different query tasks have different characteristics and, thus, CPU time does not determine network utilization. For example, two join tasks executing concurrently may require the same CPU time but have a completely different result size. If the first join floods the network with data transfer requests before the second join makes its own requests, then the consumer task for the second join will be delayed while waiting for data from the network. Hence, fairness requires that network bandwidth is also fairly split between the queries.

Second, queries compete for the total system's memory. On some occasions, running more queries results in memory allocation requests that cannot be served because the rest of the system's memory is allocated to other queries. In such cases, queries fail with an OOM error. Many systems lack a comprehensive mechanism for addressing such scenarios. One approach for addressing this scenario is to implement a configuration for the maximum allowed concurrency that can avoid such scenarios. However, a fixed concurrency threshold has two limitations: (1) it cannot avoid OOM errors with permitted concurrency levels (e.g., such issues can occur with as few as two queries), and (2) it needlessly restricts concurrency for queries that require little memory. Another approach for addressing OOM errors is to implement the notion of containers in order to reserve a fraction of the memory for a given query. While containers provide a guarantee to the query that it will avoid OOM if it requires less than the requested memory, using containers is a conservative approach that will disallow using more of the system's memory, when it is available. Lastly, another approach for addressing OOM errors is to implement an OOM prevention mechanism that uses a reserved memory pool for executing a single prioritized query until completion or OOM, when the non-reserved memory pool runs out. However, such an approach takes action too late and restricts concurrent execution from benefitting from the full system memory.

OOM errors result in two negative effects. First, OOM errors impact reliability and expose a non-deterministic behavior to the customer. A query succeeds or fails based on what other queries are running at the same time. This impacts user experience and makes debugging more complicated. Second, there is wasted processing and resource utilization time. All the CPU and network time that the query consumes before it results in an OOM error is wasted. The useful work done by the system corresponds to a fraction of the system's uptime and a fraction of the system's cost. This problem is further aggravated when the system is clogged by persistent retries for the failed queries that try to make up for the unreliability.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates a query plan of an example join query and utilization of execution time and network time in a serialized execution approach;

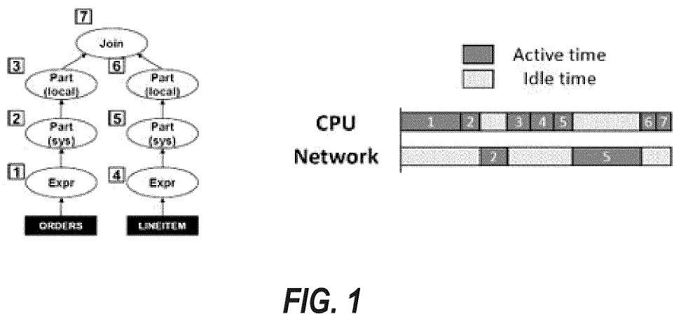

FIGS. 2A-2B illustrate improved predictability and throughput through a concurrent execution approach;

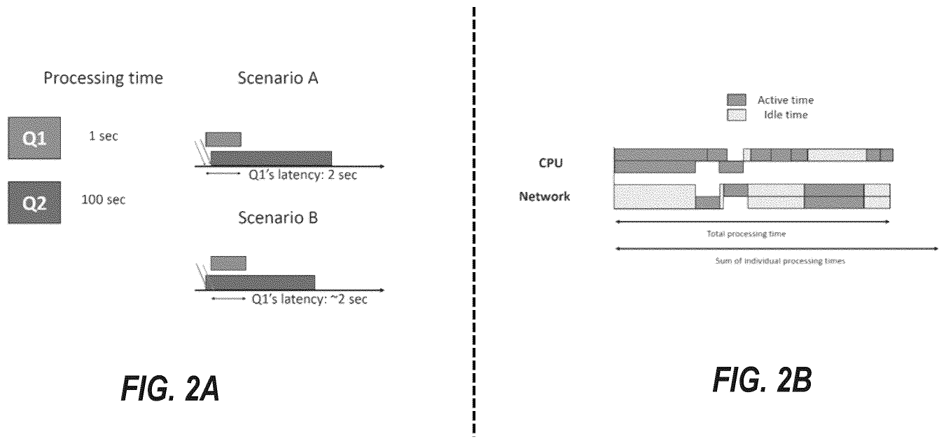

FIG. 3 is a block diagram that depicts an example computer system for concurrent query execution, in an embodiment;

FIG. 4 is a flow diagram that depicts steps that a concurrency regulator performs, in an embodiment;

FIG. 5 is a flow diagram that depicts an example process that a retry handler implements, in an embodiment;

FIG. 6 is a flow diagram that depicts an example process of retrying a query that experienced an OOM error, in an embodiment;

FIG. 7 is a flow diagram that depicts an example process for updating a local pass of a query based on how long it waited for a data transfer, in an embodiment;

FIG. 8 is a flow diagram that depicts an example process for a scheduler operating in OOM prevention mode, in an embodiment;

FIG. 9 is a block diagram that illustrates a computer system upon which an embodiment of the invention may be implemented.

FIG. 10 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for real-time scheduling of concurrently executing queries. In one technique, the time that a query waits for a data transfer to occur is taken into account when scheduling the query for execution relative to scheduling other queries for execution. In another technique, a computer system enters OOM prevention mode when it is determined that total memory resources might be exceeded, resulting in identifying one or more queries for prioritizing and pausing the non-prioritized queries. In another technique, if a query fails due to an OOM error, then, after the other concurrent queries finish executing, the failed query is retried in a serialized manner.

Embodiments improve computer-related technology pertaining to distributed query processing. Embodiments achieve predictability, high throughput, and/or reliability for concurrent execution in a distributed environment where queries run in a parallel manner. Embodiments achieve predictability by not only sharing CPU time, but also considering network transfer time across concurrent queries. Embodiments achieve reliability by allowing for the full use of a computer system's total memory by masking concurrency-induced OOM errors through an internal retry process. Embodiments achieve high throughput by exploiting opportunities to increase hardware utilization through overlaps and minimizing wasted work due to masked OOM errors.

### System Overview

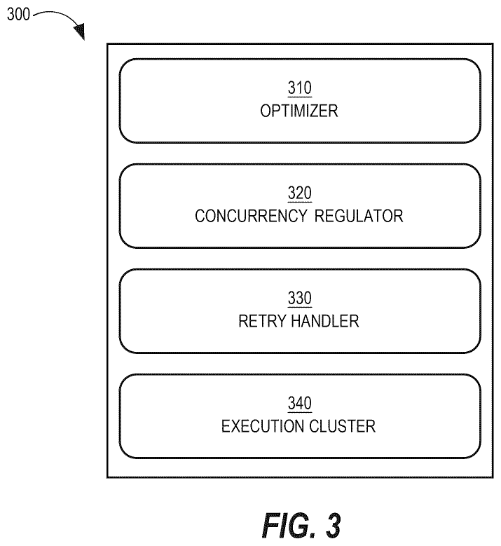

FIG. 3 is a block diagram that depicts an example computer system 300 for concurrent query execution, in an embodiment. Computer system 300 includes an optimizer 310, a concurrency regulator 320, a retry handler 330, and an execution cluster 340. Computer system 300 may comprise additional components. Optimizer 310 analyzes a query and generates an execution time estimate and a memory usage estimate. The execution time estimate is an estimate of the amount of time required to execute the query if the query is executed in a serial manner, i.e., without concurrently executing any other queries. The memory usage estimate is an estimate of the amount of memory that will be required to store data that is used to execute the query.

Concurrency regulator 320 determines when to submit each of the incoming queries to execution cluster 340 for concurrent execution so that the risk of internal OOM errors is low. Each query selected by concurrency regulator 320 is then passed to retry handler 330, which submits the query to execution cluster 340 for execution until the query succeeds or until retry handler 330 determines that the error is not concurrency-induced. Inside execution cluster 340, one or more queries are executed concurrently. During that time, allocation of resources to queries is controlled by local schedulers and an OOM prevention mechanism. Eventually, once retry handler 330 is done with a query, the query's result or error is returned to the client that submitted the query.

### Concurrency Regulator

Allowing all incoming queries, which can be arbitrarily many, to run concurrently may result in high memory utilization. In such situations, risk of OOM errors may be detected too late during query execution. Several queries may need to be terminated to free enough memory so that other queries finish successfully. Such scenarios result in significant wasted processing and are undesirable. For this reason, a concurrent execution framework should proactively choose to restrict which queries run concurrently and make such termination cases rare.

Limiting the level of concurrency presents a trade-off. Running all queries at once allows for maximizing fairness because all queries make progress but results in high demand for memory. In contrast, restricting concurrency decreases demand for memory, but the latency of waiting queries may be unfairly penalized. Concurrency regulator 320 balances between these two factors by choosing the maximum level of concurrency that has low risk of OOM errors for executing the queries that are more prone to suffer from unfairness.

In an embodiment, to strike a balance between OOM risk and risk of unfairness, concurrency regulator 320 estimates the priority of each query, similar to the serialized priority queue, and selects the maximum number of queries that it predicts can be admitted in the order of priority and can run with low risk of OOM errors. For this purpose, concurrency regulator 320 extracts, from each query's physical plan, an estimate for the required execution time and an estimate for the peak memory utilization. Concurrency regulator 320 uses these two features to decide when the query's execution should start, at which moment concurrency regulator 320 passes the query to retry handler 330.

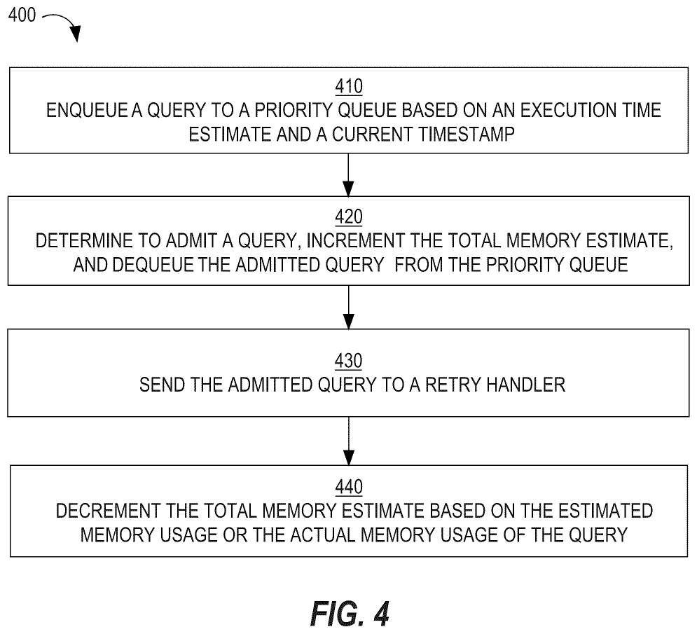

FIG. 4 is a flow diagram that depicts steps that concurrency regulator 320 performs, in an embodiment. Concurrency regulator 320 comprises a priority queue. For each incoming query, concurrency regulator 320 enqueues 410 the query based on an execution time estimate and a current timestamp. Enqueueing 410 may involve computing a priority for the query, assuming a serialized execution model. The priority may be computed as follows. Concurrency regulator 320 finds a position, in the priority queue, at which the query should be added. Concurrency regulator 320 iterates through the priority queue from the front and computes when the query in each position is predicted to run. The estimated admission time is the estimated finish time for currently running queries plus the estimated execution times for the queries iterated so far. This directly gives an estimated wait time as:

estimated wait time=estimated admission time−arrival time

The estimated wait time is then used to compute a weight for both the incoming query and the query that is currently in the position at hand:

weight=estimated wait time/estimated execution time

If the incoming query's weight is greater than the weight of the query currently in the position, then the incoming query is inserted ahead of compared query. This priority scheme incorporates the currently-running queries in the wait time as well.

Each query stays in the priority queue until the query reaches the front and there is sufficient memory for the query to execute with low risk of OOM. The risk condition is evaluated using the memory usage estimates. Concurrency regulator 320 computes an estimated total utilization by summing up the estimates of the currently running queries and the query at the front of the queue and compares this total with the available system memory, excluding the memory used by base tables and some critical processes, such as update propagation. If the total, which includes the query at the front of the queue, is less than the available system memory, then concurrency regulator 320 admits the query at the front for execution. If there are no currently running queries, then the query at the front of the queue is admitted unconditionally to account for cases where concurrency regulator 320 expects a query to receive an OOM error. In such cases, the query must still run to account for cases when memory has been overestimated.

In response to determining to admit a query to retry handler 330, concurrency regulator 320 increments 420 the total memory estimate and dequeues the admitted query from the priority query of concurrency regulator 320. Concurrency regulator 320 also sends 430 the admitted query to retry handler 330. After a query finishes executing, concurrency regulator 320 decrements 440 the total memory estimate based on the estimated memory usage or the actual memory usage of the query.

In an embodiment, concurrency regulator 320 checks whether there is an opportunity to schedule the query at the front of the queue reactively, to avoid depleting compute time with busy waiting. Hence, concurrency regulator 320 may check the admission condition (for admitting a query at the front of the priority queue) in one or more events, such as any of the following: (a) a new query is added to the priority queue and becomes the new query at the front of the priority queue; (b) a query is finished (because the estimated total memory changes); (c) the query at the front of the priority queue is killed; and (d) the query at the front of the priority queue is admitted for cases when the remaining memory is sufficient for the query in line.

Overall, in an embodiment, concurrency regulator 320 adaptively controls the level of concurrency to maximize concurrency while limiting the risk of an OOM error. Concurrency regulator 320 prioritizes queries that are predicted to have a worse relative slowdown when determining the admission order by using the same idea as priority-based serialized execution. Nevertheless, as concurrency regulator 320 permits admitting more queries compared to the priority-based serialized execution, concurrency regulator 320 is less sensitive to inaccurate execution-time and query arrival timing because the occasional long-running query executed out of order rarely blocks shorter-running queries and it suffices that some ongoing shorter-running queries finish to unblock a high-priority waiting query.

### Retry Handler

The priority queue attempts to prevent OOM errors in a best-effort manner. However, as query execution is unpredictable, it is always possible that a query requests more memory than expected (or total system memory decreases for another reason) and, therefore, results in an OOM error. A purpose of retry handler 330 is to verify whether an OOM error in a cluster of nodes is concurrency-induced and, if so, retry a query until the query succeeds or it becomes clear that the error is not caused by concurrent execution. The aim of this behavior is to make the success or failure of each query deterministic with respect to concurrency and, thus, improve user experience.

In an embodiment, retry handler 330 implements one or more retry policies. Examples of a retry policy include retry serialized, exponential backoff, and persistent back-to-back retries. In an embodiment, retry handler 330 implements a retry serialized policy, which is to repeat a query (that failed with an OOM error while running concurrently with one or more other queries) only once in a serialized manner (i.e., without any other queries running concurrently in any node of the cluster). This retry policy is beneficial for at least two reasons: (1) this retry policy minimizes wasted processing as queries suffering from concurrency-induced OOM errors only fail once, and (2) the impact of serialization on fairness is less important because wasted processing already entails a throughput regression compared to the prior priority-based serialized execution framework. If the serialized retry fails, then the OOM error is not caused by concurrency and the error is reported back to the client.

A variation of the retry serialized policy is the exponential backoff policy where the level of concurrency is reduced dramatically (e.g., exponentially) in response to an OOM error rather than eliminated altogether. For example, if there were seven concurrently running queries when a query experienced an OOM error, then the level of concurrency is reduced to two concurrently running queries when the query that experienced an OOM error is executed again.

A persistent back-to-back retry policy is where a query that failed due to an OOM error is retried immediately. If the query fails again, then the query is retried again. This process continues until the query succeeds or fails while no other queries are concurrently running in the cluster.

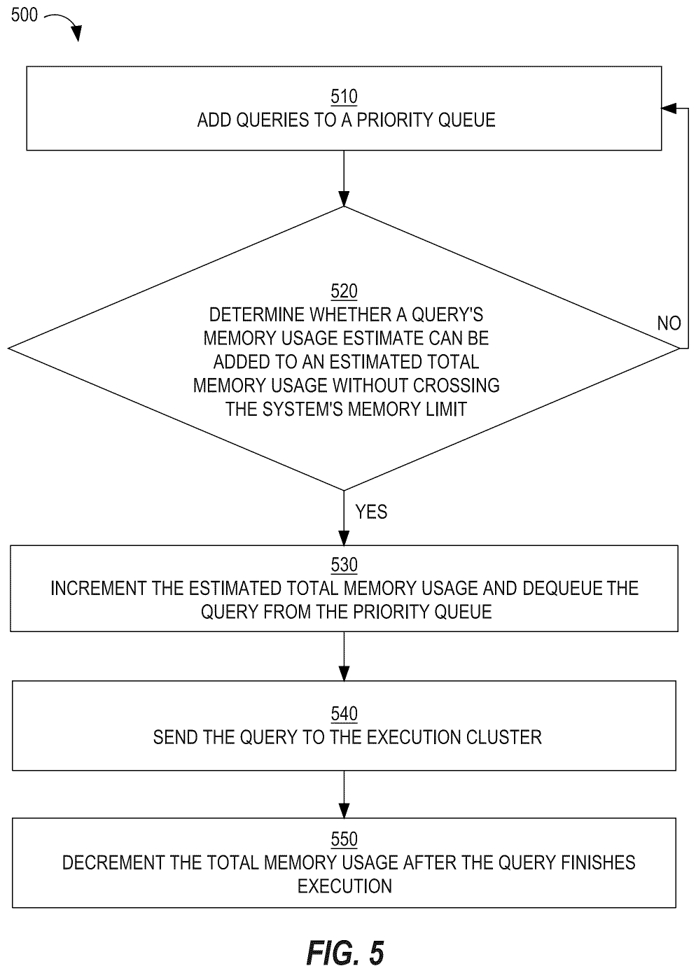

FIG. 5 is a flow diagram that depicts an example process 500 that retry handler 330 implements, in an embodiment. Retry handler 330 receives queries from concurrency regulator 320. Retry handler 330 acts as a concurrency regulator for the currently-submitted queries and any of their respective retries. Retry handler 330 adds 510 queries to a priority queue and determines 520 whether a query's memory usage estimate can be added to the estimated total memory usage without crossing the computer system's memory limit. When a positive determination is made, retry handler 330 increments 530 the estimated total memory usage, dequeues the query from the priority queue, and sends 540 the query to execution cluster 340. After execution, retry handler 330 decrements 550 the estimated total memory usage based on the query's actual memory usage or memory usage estimate.

If a query succeeds or receives any other error, then that query exits the domain of retry handler 330. However, if a query results in an OOM error, then retry handler 330 checks a retry condition of the query. If the query is a retry itself or no other query overlapped with it in the cluster, then the query again exits the domain of retry handler 330. Otherwise, retry handler 330 adds the query to the priority queue and sets the memory usage estimate of that query to a value that exceeds the system's memory. Such a setting prevents the query from running concurrently with any other query. When this query reaches the front of the priority queue again and the cluster has no other ongoing queries, retry handler 330 causes the query to be retried (or executed again). In an embodiment, regardless of the result of this retry, the query will exit the domain of retry handler 330. In a related embodiment, the query may be retried again.

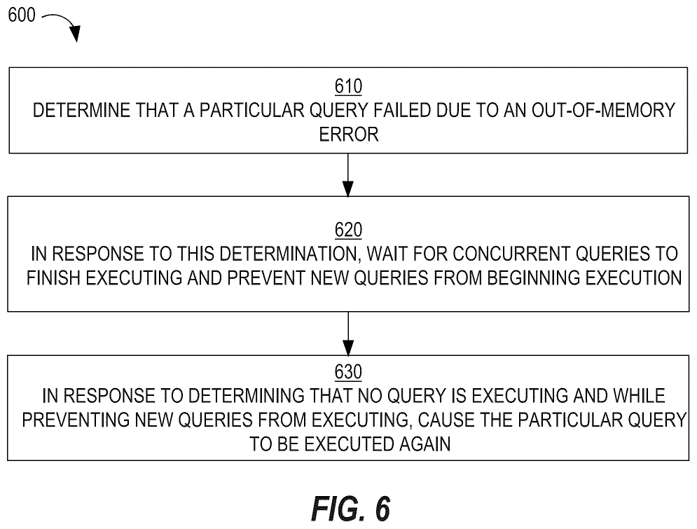

FIG. 6 is a flow diagram that depicts an example process 600 of retrying a query that experienced an OOM error, in an embodiment. Process 600 may be performed by retry handler 330.

At block 610, it is determined that a particular query, of multiple queries, failed due to an OOM error. Block 610 may be performed while the multiple queries are executing concurrently.

At block 620, in response to this determination, a process (e.g., retry handler 330) waits for the other queries of the multiple queries to finish executing. Block 620 also involves preventing new queries from beginning execution. “New” queries are queries that arrive after the OOM error or that were waiting to begin executing while the particular query was executing. Thus, while the other queries are waited for to finish executing, one or more new queries may arrive at computer system 300 or at a specific core of computer system 300.

At block 630, in response to determining that no query is executing and while preventing new queries from executing, the particular query is caused to be executed again. Thus, during blocks 620 and 630, no new queries are allowed to execute. Only after the particular query finishes executing are any new queries allowed to execute.

### Execution Cluster

Execution cluster 340 executes queries that it receives concurrently. To achieve predictable performance for each of the running queries, execution cluster 340 performs fair resource sharing, i.e., to allocate the same fraction of utilization time for each resource (CPU, network) to each query. At the same time, in order to improve resource utilization and decrease idle time, execution cluster 340 permits a query to use different resources at different times. For example, data transfers are decoupled from allocation of CPU time so that a first query can runs its CPU and memory bandwidth-intensive task in parallel with the data transfer pertaining to a second query.

Different models and abstractions have been used in the past for fair resource sharing. Some approaches use OS abstractions, such as different threads and network connections, and leave resource sharing to the OS. These approaches may result in high overhead as concurrency is increased and may fail to provide a fair allocation over shorter periods, such as the duration of a fast query. Other approaches physically partition computer resources and allocate them to each query, e.g., allocate specific cores to a query, but provide less flexibility with respect to dynamic workloads (both in terms of arrival and departure of queries, and queries shifting between CPU and network intensive phases).

Additionally, there are approaches, including scale-up databases as well as other approaches that time-share each resource across available queries by multiplexing the work from different queries in fine granularity. The last approach of multiplexing has low overhead, works in fine granularity, and adapts well to a dynamic workload. Queries share the same query execution threads as well as the same network connections across nodes and to a database. Execution threads, which are affinitized to one core each, and network connections are controlled by dedicated schedulers that multiplex the work coming from each query. In the following section, the operation of each of these computing resources and their interaction through the shift between CPU and network-intensive phases are presented.

### Execution Cluster: Core Schedulers

Execution cluster 340 comprises a scheduler for each core. A per-core scheduler for a CPU core fairly splits the core's utilization time across concurrent queries. However, in each core, all queries use the same thread and, as a result, only one query can execute at any given time. Hence, the query execution thread multiplexes work coming from different queries at each step. The scheduler selects a query to run for a “quantum,” which is an uninterrupted period of core-time. After a quantum, the query yields back to the scheduler so that the schedule may select the next query. The next time the scheduler selects a query, the query resumes execution from the state it was left at the end of the previous quantum for that query.

In an embodiment, queries support quantum-based execution in two ways: (1) the ability to yield and resume, and (2) the ability to decide when to yield. These two properties are implemented at the level of tasks. Each task consists of a pipeline of one or more operators. Both the pipeline orchestration code as well as each operator in the pipeline have yield points where a decision to yield can be made. The yield decision is based on a timeout, the countdown of which starts from the start of the quantum. When query execution decides to yield, the task backs up the operator and the pipeline state in in-memory structures that are specific to the currently running operator and the pipeline's implementation. Later, when resuming, the task checks whether it has yielded before, and if so, restores the pipeline and operator state and jumps to the code that follows the yield point that was last triggered.

Queries might not always be available for scheduling, for example, because their next task is waiting for data transfers from a previous task. For this reason, a scheduler may keep track of each query's state and use this state to make scheduling decisions. A scheduler may classify a query in one of three states: Active, Pending, and Finished. Active queries are available for scheduling and, thus, are the only candidates for allocating the next quantum. Pending queries are currently blocked by a data transfer, but they are not finished overall. A pending query has more tasks to complete but is not currently running a task and is blocked until its next task sends a yield signal to the scheduler. The next task will send the yield signal when (1) its required data has been transferred (so the transfer blocks the task) and (2) it has been notified that the previous task is finished (so it might take some microseconds to notify it and send the yield signal even if there is no transfer blocking it, at that time the query is pending for the scheduler). Finished queries have finished processing for this core and node and will be removed when their memory utilization hits zero. The scheduler maintains a list of queries in each state.

Query states are updated through yield signals from query tasks to the scheduler. When a query starts the next task, in which case it is available for scheduling, the task sends a yield signal to the scheduler to register itself. If a query is new, then the scheduler adds the query to an Active list; otherwise, the scheduler moves the query from a Pending list to the Active list. Each yield due to a timeout returns control to the scheduler through the yield signal; however, the query remains Active. When the task is done, a yield signal is sent to the scheduler and the query becomes Pending if there are more tasks to process or the query becomes Finished. There are two scenarios when a scheduler receives a yield signal from a task: (1) the task attempts to register itself (in which case the corresponding query is new or Pending) and (2) the task finished a quantum and informs the scheduler that the quantum is finished. After the task has sent the yield signal, the task remains idle and does not send any other messages until the scheduler chooses it to run for another quantum. After processing a yield signal, the scheduler checks if there is already a scheduled query for the next quantum and, if not, the scheduler attempts to make a scheduling decision. Overall, yield signals drive per-core schedulers. Schedulers do not handle query orchestration, which is done by an independent worker that spawns and starts tasks at cores when their input is ready for consumption.

When queries move to a Pending state during their execution, the scheduler continues assigning quanta to queries that are still in the Active state. In this way, the scheduler allows queries to run during what would be idle time for serialized execution. This opportunistic strategy enables improving throughput by improving the utilization of each core's time.

In an embodiment, per-core schedulers use stride scheduling in selecting the next query to schedule. Stride scheduling works as follows. For each query qᵢ, a scheduler maintains a per-query quantity Pᵢ (referred to as a “pass”) and a quantity P (referred to as a “global pass”). The per-query pass may be considered a local counter or a clock that moves forward every time a corresponding scheduler schedules the corresponding query and the global pass may be considered a global counter whose value queries should have had if scheduling was ideal, i.e., infinitesimal quanta. Stride scheduling works by minimizing the difference between the query with the lowest pass and the query with the highest pass. Therefore, in each scheduling decision, a scheduler chooses the Active query that has the lowest pass. When the query yields again, the scheduler takes metadata attached to the yield, such as the duration of the quantum, and updates the query's pass and the global pass. Let query qᵢ be the one executing for a time duration tᵢ, the timeout is T, and there are N registered tasks. Then, passes are updated as follows:

$${P}_{i} ← {P}_{i} + {t}_{i} / T$$

$$P ← P + {t}_{i} / ( T * N )$$

By minimizing the gap between the lowest and highest pass, stride scheduling ensures that roughly the same time has been allocated to all queries, which maximizes fairness. The global pass is used for assigning the initial pass value to each incoming query.

The key tuning knob for the scheduler is the timeout duration. Very short quanta affect performance due to context switching overhead, whereas very long quanta affect fairness because queries can then occupy CPU for a long time before allowing a short-running query to run. An example for the value for T is 32 milliseconds.

### Execution Cluster: Network Scheduler

As queries use the same network connections across nodes in a cluster of nodes, the utilization time for the network should also be split across the queries through multiplexing. However, network usage has some distinctive characteristics from CPU core usage. First, data transfers are naturally quantized because data transfers are broken down into messages. Second, since there is a pool of network workers that actuate network transfers, there are multiple in-flight messages that are being sent in parallel.

In an embodiment, a network scheduler of execution cluster 340 implements stride scheduling for outgoing data transfers. The network schedule takes into account distinctive characteristics of the network. The network scheduler focuses on outgoing data because a node cannot control what data it receives.

Prior to a concurrent execution framework, prior approaches used a FIFO queue to send data messages from one node to another. Tasks from Active queries submitted messages to the FIFO queue and the FIFO queue asynchronously forwarded each message to the pool of network workers for transferring the data. In contrast, in an embodiment, the concurrent execution framework replaces the FIFO queue with a fair queueing component. Running tasks still submit messages to a common queue along with a label uniquely identifying the corresponding query. A network scheduler thread dequeues messages from the common queue and places the messages to a queue dedicated to the message's corresponding query. (The placing of a message to the queue may be performed in a zero-copy way, which means, instead of copying the whole network message (which is costly), the network scheduler enqueues a pointer/address to the network message.) Once the common queue is empty, the network scheduler posts messages from the per-query queues until there is a desired number of in-flight messages. An in-flight message is a request where the sender of the request is waiting for data to be returned based on the request. For each post, the network scheduler selects one of the per-query queues, removes the first message from the selected per-query queue, and posts that first message. Messages for the same query are not re-ordered and, thus, guarantee ordering semantics.

In an embodiment, the network scheduler uses stride scheduling to select from among multiple per-query queues, from which to post a message. Again, the network scheduler uses a pass for each query as well as a global pass, and uses the same formulas for updating the two quantities. If the network scheduler posts a message for query qᵢ, which takes tᵢ time to transfer, the timeout is T, and there are N queries that have a message to send, then it updates passes as follows.

$${P}_{i} ← {P}_{i} + {t}_{i} / T$$

$$P ← P + {t}_{i} / ( T * N )$$

However, there are two key challenges for network transfers. First, the update of passes needs to happen at the time of posting the messages, to avoid only posting messages for the query with the lowest pass. The value of tᵢ is needed to update the pass but it is only known after the message (or “network packet”) is sent. Second, the message may not have exclusive access to the network due to the network workers working in parallel and, thus, transfer time measurements may be noisy. In an embodiment, to address these two issues, an estimate of tᵢ is determined based on a measurement of the network bandwidth (NB). The network scheduler (or another component of computer system 300) monitors the total amount of data sent over the network and computes the NB, and then it estimates tᵢ using the following formula.

$${t}_{i} ← ( message size ) / NB$$

Using an estimate for transfer time avoids imbalanced post decisions and the use of noisy measurements and, thus, improves scheduling decisions.

### Execution Cluster: Dynamic Resource Allocation

Stride scheduling works poorly when a query uses only one of the resources (e.g., a CPU core or the network) for a prolonged time period. For example, whenever a particular query does not use a resource because of a dependency for a long time (e.g., it has to process a node-local sort operator on a large volume of data, so it does not use the network in the meantime), the pass of the particular query falls far behind the passes of other queries. Then, when work for that resource becomes available (e.g., transferring the resulting data), the particular query is prioritized over work of any other query until the pass of the particular query catches up to the passes of other queries. If a short-running query requires the resource for a small amount of work, then it will have to wait and suffer significant delay.

It is observed that a query needs an equal fraction of each resource, not during its lifetime, but during the time that it requires access to the resource. In the example above, the network scheduling pass of the particular query should not fall behind other queries because there are no messages to send in the meantime. This effect may be achieved by using a dynamic scheduling model, in an embodiment. Each time a query's available work for a resource is temporarily finished (e.g., until data becomes available for the next task or there is new data to send over the network), the network scheduler computes and stores, with the query's scheduling metadata, the difference of the query's pass from the global pass. When the query once again has work that uses the resource, the network scheduler recalculates the query's pass by adding the stored difference to the current global pass. When initializing a query, its difference for all schedulers is set to 0 so the query's pass is set to the global pass. Through these corrections, the stride schedulers only factor in the unfairness for the time period when the query can actually use the resources, which improves overall end-to-end fairness.

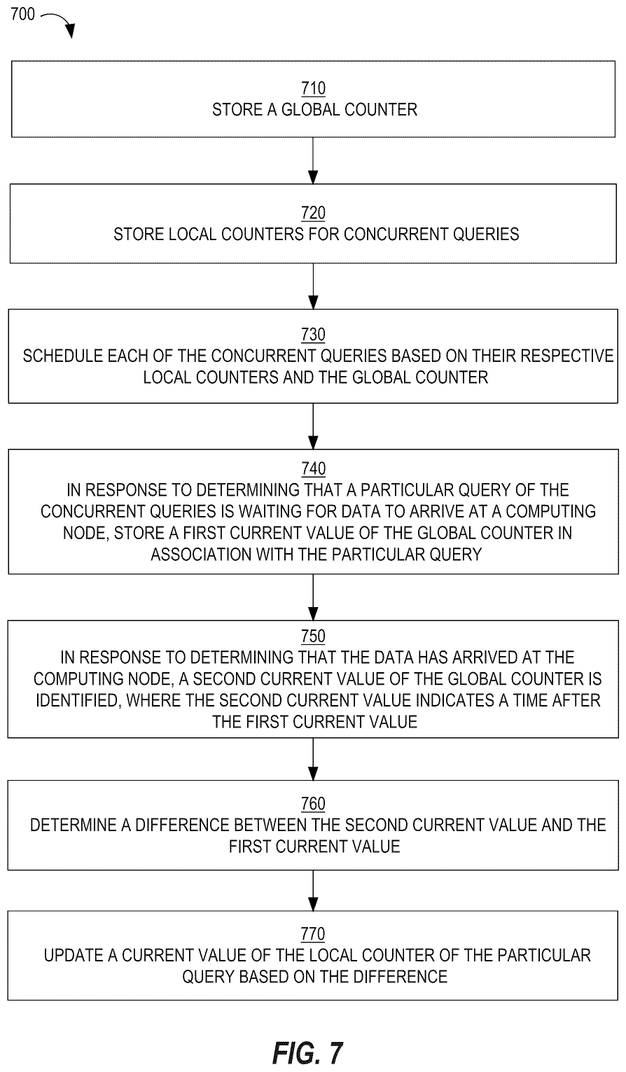

FIG. 7 is a flow diagram that depicts an example process 700 for updating a local pass of a query based on how long it waited for a data transfer, in an embodiment. Process 700 may be performed by a core scheduler.

At block 710, a global counter (or global pass) is stored that changes with the passage of time. The global counter may be initialized to zero before any queries arrive (or are accessible to the scheduler).

At block 720, multiple local counters (or local passes) are stored, each local counter corresponding to a different query of a plurality of queries. Initially, when a query arrives, the local counter of the query is set to be the value of the global counter.

At block 730, each query of the multiple queries is scheduled based on the local counters and the global counter. For example, for each scheduling decision, the scheduler selects the query that is associated with the local counter having the lowest value.

At block 740, in response to determining that a particular query of the multiple queries is waiting for data to arrive at a computing node, a first current value of the global counter is stored in association with the particular query. The waiting may have begun after a request for the data was transmitted from the computing node to another computing node. Thus, blocks 710-770 may be performed by the computing node, which is one of multiple computing nodes in a cluster of computing nodes. Alternatively, the waiting may have begun after a request for the data was transmitted from the computing node to a database or other storage system that is communicatively coupled with computer system 300.

At block 750, in response to determining that the data has arrived at the computing node, a second current value of the global counter is identified, where the second current value indicates a time after the first current value.

At block 760, a difference between the second current value and the first current value is determined. For example, the first current value is subtracted from the second current value, indicating that the difference is a positive value, assuming that the global counter increases as time passes.

At block 770, a current value of the local counter of the particular query is updated based on the difference. Block 770 may involve adding the difference to the current value of the local counter. Therefore, the scheduler makes a scheduling decision based on the current values of the local counters of the current concurrently executing queries.

### Real-Time Oom Error Prevention

Concurrency regulator 320 ensures that the concurrency of submitted queries is such that OOM errors are not expected, based on the estimates, to occur. However, estimates generated by optimizer 310 are prone to error. If optimizer 310 underestimated the memory utilization of queries, then memory pressure can build up, resulting in execution cluster 340 experiencing internal OOM errors. While these errors are masked by retry handler 330, these errors result in wasted processing time and decrease throughput.

In an embodiment, to safeguard against memory underestimation, per-core schedulers detect when underestimation introduces an elevated risk of OOM errors and takes preventive actions. Each per-core scheduler keeps track of worst-case memory utilization. For each query qᵢ, a per-core scheduler computes a memory reservation as:

memory_reservation(qᵢ)=max(memory_estimate(qᵢ),currently_used_memory(qᵢ))

The “memory_estimate” is the memory usage estimate used by concurrency regulator 320. (This memory usage estimate is also referred to as “expected peak utilization.”) The currently_used_memory may be tracked using per query memory counters.

Whenever the sum of memory reservations for ongoing queries exceeds the total system memory, a per-core scheduler enters an OOM error prevention mode. OOM error prevention mode may be triggered due to two scenarios: (1) one or more queries have exceeded their respective memory estimates and (2) the total system memory has decreased (e.g., due to a background task running).

During OOM error prevention mode, queries are split into two categories: prioritized and non-prioritized. A per-core scheduler only assigns quanta to Active queries that are also prioritized. Initially all queries are non-prioritized. The per-core scheduler looks for queries to prioritize across both Active and Pending queries. If there are ongoing queries but there is no prioritized query, then the per-core scheduler looks for a query that has exceeded its memory estimate and prioritizes that query. If there is no such query, then the per-core scheduler prioritizes the query that has run for the least amount of time and, thus, would minimize the waste of processing if that query received an OOM error. The prioritized queries run until they finish or receive an OOM error. The per-core scheduler exits OOM error prevention mode when the sum of memory reservations once more drops below the total system memory.

With this prioritization policy, queries that exceed their memory usage estimates bear most of the risk for terminating due to an OOM error, whereas queries that have accurate estimates or underestimate their memory have the least risk of terminating with an OOM error. A key insight is that queries that run frequently have their statistics cached and, thus, their estimates are frequently accurate. Furthermore, queries that exceed their memory usage estimates are to blame for triggering the OOM error prevention mode and will leave enough memory for the rest of the queries to run with full concurrency when these prioritized queries finish or abort.

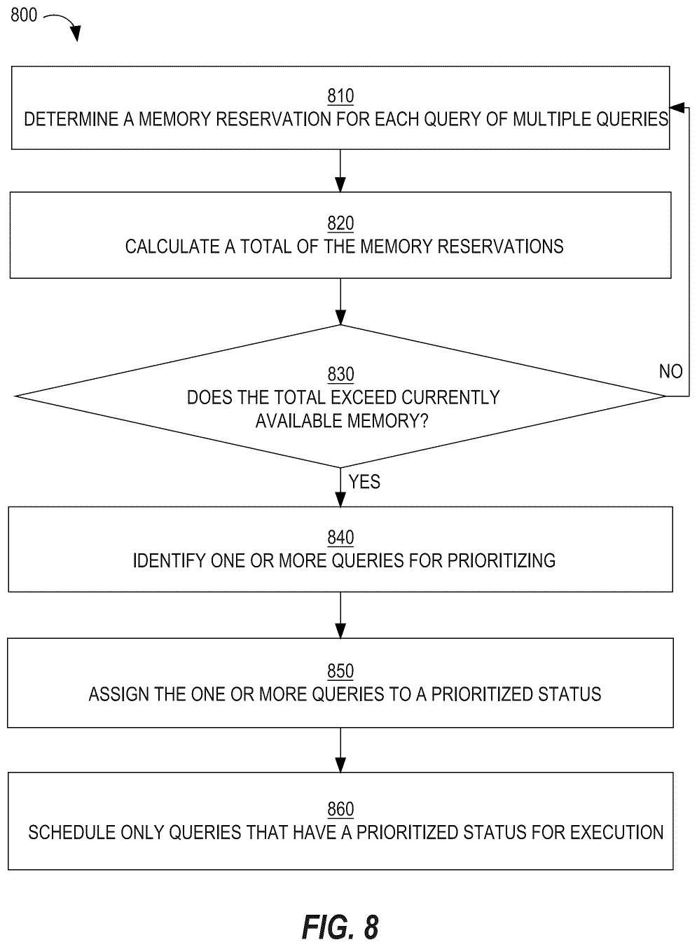

FIG. 8 is a flow diagram that depicts an example process 800 for operating in OOM prevention mode, in an embodiment. Process 800 may be performed by a core scheduler.

At block 810, a memory reservation is determined for each query of multiple queries. The memory reservation of a query may be the maximum of (a) a memory usage estimate for the query and (b) a current memory usage of the query.

At block 820, a total of the memory reservations is calculated. Block 820 may involve summing all the memory reservations of the multiple queries.

At block 830, it is determined whether the total exceeds currently available memory. “Currently available memory” is memory that is currently used by the multiple queries and memory that is not currently used by any of the multiple queries, but that could be used by any of the multiple queries or additional queries. Thus, some system memory might not be available for processing any queries. If the determination of block 830 is positive, then process 800 proceeds to block 840.

Otherwise, process 800 returns to block 810. In a second iteration of block 810, the memory reservation of a query may change relative to the first iteration of block 810. For example, the current memory usage may have increased between the first iteration and the second iteration. Also, in a second iteration of block 830, currently available memory may have changed relative to the first iteration of block 830. For example, the amount of currently available memory may have decreased between the first iteration of block 830 and the second iteration of block 830.

At block 840, in response to determining that the total exceeds (or might exceed) currently available memory, one or more queries from among multiple queries are identified for prioritizing. The identification is based on one or more criteria. For example, the one or more criteria may comprise that the currently-used memory of a query exceeds a memory usage estimate for that query. As another example, the one or more criteria may comprise a query that has run for the least amount of time.

At block 850, the one or more identified queries are assigned to a prioritized status. Block 850 may involve setting a particular bit (associated with an identified query) to 1 or setting a prioritized status variable (associated with the identified query) to true.

At block 860, only queries that have a prioritized status are scheduled for execution. There may be only a single prioritized query or there may be multiple prioritized queries. Other queries that may have been concurrently executing with prioritized queries are not scheduled for execution. Such queries are effectively paused until the prioritized queries finish executing or abort, such as due to an OOM error.

If a prioritized query fails due to an OOM error, then the scheduler may wait for any concurrently executing queries to finish executing. These concurrently executing queries include all non-prioritized queries. Also, the scheduler prevents new queries from executing. Then, in response to determining that the concurrently executing queries have finished executing and while new queries are prevented from executing, the particular query is caused to be executed again.

A key challenge for OOM prevention is skew across nodes in a cluster. Queries have different memory utilization across different nodes. Without synchronization, this could lead to deadlocks. For example, if node A prioritizes q₁ and node B prioritizes q₂ in node B, then q₁ will never receive the intermediate results required for its next task in node A from node B. In an embodiment, to eliminate the risk of deadlocks, prioritization decisions are propagated across all cores of a node and nodes of a cluster. Each time a per-core scheduler makes a prioritization decision, the scheduler sends a message to each other scheduler in a cluster. The receiving schedulers prioritize the query that the original scheduler prioritized. If a scheduler prioritizes a different query before it receives a prioritization message, then the cluster's schedulers will have more than one prioritized query and perform stride scheduling among all of the prioritized queries that are active.

Therefore, in an embodiment, the one or more queries identified in block 840 are executing on a first computing node of a cluster of computing nodes. Accordingly, in this embodiment, block 850 may involve transmitting, to one or more other computing nodes in the cluster, a message that indicates that the one or more identified queries are prioritized. This ensures that any tasks, related to the one or more identified queries, on the one or more other computing nodes, continue to be performed.

### Hardware Over View

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

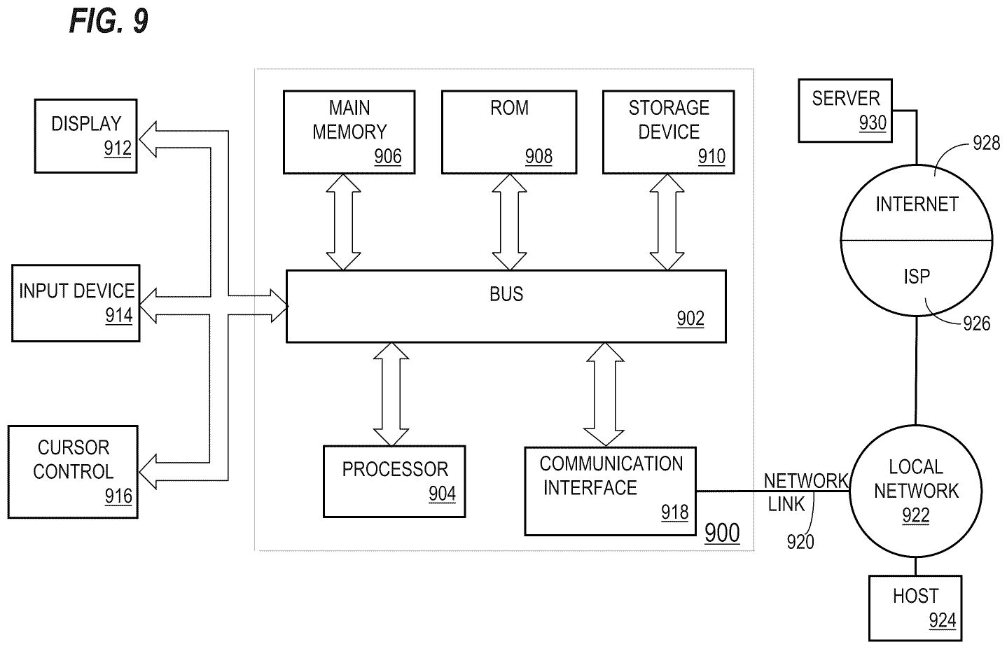

For example, FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Overview

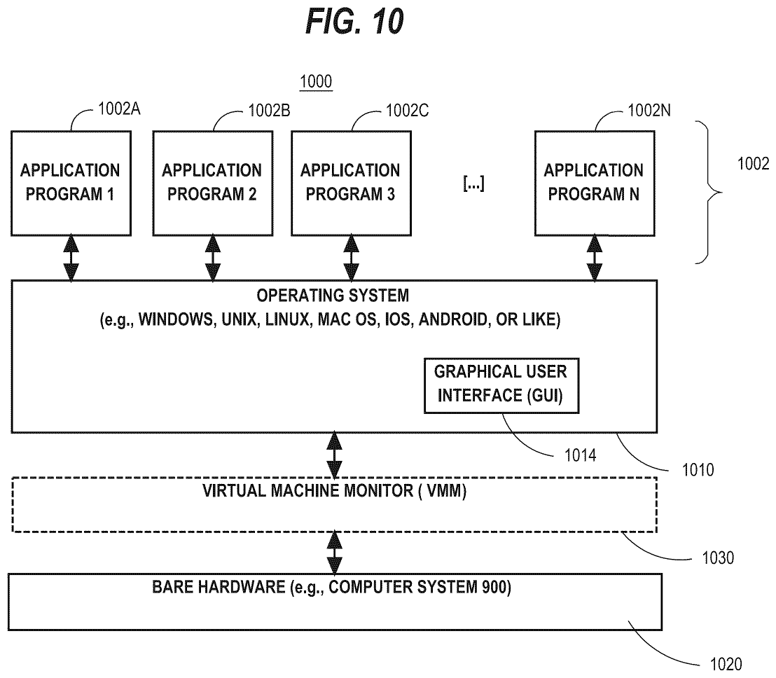

FIG. 10 is a block diagram of a basic software system 1000 that may be employed for controlling the operation of computer system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computer system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by the system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 900 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a global counter that changes with the passage of time;
storing a plurality of local counters, each local counter corresponding to a different query of a plurality of queries;
scheduling each query of the plurality of queries based on the plurality of local counters and the global counter;
in response to determining that a particular query of the plurality of queries is waiting for data to arrive at a computing node, storing, in association with the particular query, a first current value of the global counter;
in response to determining that the data has arrived at the computing node:
identifying a second current value of the global counter, wherein the second current value indicates a time after the first current value;
determining a difference between the second current value and the first current value;
updating a current value of the local counter of the particular query based on the difference;
wherein the method is performed by the computing node.

2. The method of claim 1, wherein the computing node transmits the request to another computing node in a cluster of computing nodes.

3. The method of claim 2, further comprising:
maintaining a common queue for network messages from multiple queries;
maintaining a plurality of query-specific queues;
removing, from the common queue, a network message and adding the network message to a query-specific queue;
using stride scheduling to select network messages from the plurality of query-specific queues.

4. The method of claim 3, further comprising:
maintaining a local network counter for each query-specific queue of the plurality of query-specific queues;
selecting a particular network message from a particular query-specific queue of the plurality of query-specific queues;
after selecting the particular network message, updating a particular local network counter of the particular query-specific queue based on a ratio of a size of the particular network message and a measurement of a current network bandwidth.

5. The method of claim 1, wherein the computing node transmits the request to a database.

6. The method of claim 1, wherein scheduling the plurality of queries comprises:
for each local counter of the plurality of local counters:
determining a difference between a current value of the global counter and a current value of said each local counter;
storing the difference in a set of differences;
selecting a query from among the plurality of queries to schedule for processing based on the query of the plurality of queries that is associated with the largest difference in the set of differences.

7. A method comprising:
for each query of a plurality of queries:
determining a memory reservation for said each query;
adding the memory reservation to a set of memory reservations;
in response to determining that a total of the set of memory reservations might exceed currently available memory, identifying, from among the plurality of queries, based on one or more criteria, one or more queries to prioritize;
assigning the one or more queries to a prioritized status;
scheduling, for execution, only queries that have a prioritized status;
wherein the method is performed by one or more computing devices.

8. The method of claim 7, wherein the one or more criteria comprises currently-used memory of a query exceeding a memory usage estimate for the query.

9. The method of claim 7, wherein the one or more criteria comprises a query that has run for the least amount of time.

10. The method of claim 7, wherein the plurality of queries execute on a first computing node of a cluster of computing nodes, the method further comprising:
transmitting, from the first computing node to one or more other computing nodes in the cluster, a message that indicates that the one or more queries are prioritized.

11. The method of claim 7, wherein the memory reservation of said each query is the maximum of (a) a memory usage estimate for said each query and (b) a current memory usage of said each query.

12. The method of claim 7, further comprising:
determining that a particular query, of the one or more queries that have the prioritized status, fails due to an out-of-memory (OOM) error;
in response to determining that the particular query failed due to the OOM error:
waiting for one or more other queries in the plurality of queries to finish executing;
preventing new queries from executing;
in response to determining that the one or more other queries finished executing and while preventing new queries from executing, causing the particular query to be executed again.

13. A method comprising:
while a plurality of queries are executing concurrently, determining that a particular query, of the plurality of queries, failed due to an out-of-memory (OOM) error;
in response to determining that the particular query failed due to an OOM error:
waiting for the other queries in the plurality of queries to finish executing;
preventing new queries from executing;
in response to determining that no query is executing and while preventing new queries from executing, causing the particular query to be executed again;
wherein the method is performed by one or more computing devices.

14. The method of claim 13, further comprising:
prior to causing the particular query to be executed, setting a memory usage estimate of the particular query to be a value that is larger than available system memory;
determining to execute only the particular query based on the memory usage estimate.
